(19) United States
(12) Patent Application Publication
(10) Pub. No.: US 2015/0289551 A1
(43) Pub. Date: Oct. 15, 2015

(54) Ready-To-Use Mushrooms with Enhanced Vitamin D Content and Improved Shelf Life

(71) Applicants: AMYCEL, INC., WATSONVILLE, CA (US); THE UNITED STATES OF AMERICA, AS REPRESENTED BY THE SECRETARY OF AGRICULTURE, WASHINGTON, DC (US)

(72) Inventors: John W. Kidder, Aromas, CA (US); William R. Romig, Townsend, CA (US); Amada Lobato, Watsonville, CA (US); Stephen C. Lodder, Aptos, CA (US); Tara H. McHugh, Albany, CA (US); John S. Roberts, Honeoye Falls, NY (US)

(21) Appl. No.: 14/598,589

(22) Filed: Jan. 16, 2015

Related U.S. Application Data
(63) Continuation of application No. 13/585,655, filed on Aug. 14, 2012, now abandoned.
Application No. 13/585,655 is a continuation of application No. 12/437,394, filed on May 7, 2009, now abandoned.
(60) Provisional application No. 61/051,235, filed on May 7, 2008.

(51) Int. Cl. A23L 1/28; A23L 3/28

(52) U.S. Cl. CPC A23L 1/28; A23L 3/28; A23V 2002/00

(57) ABSTRACT

Described herein is the treatment of mushrooms to enhance their vitamin D content while preserving characteristics typically associated with fresh mushrooms. In one embodiment, the method involves exposing fresh mushrooms to a UV source having wavelengths in the UV-B range at a dose level in the range of about 0.02 J/cm² to about 1.5 J/cm². In some embodiments, the exposure time can be in the range of about 1 second to about 35 seconds. In some embodiments, the UV source is operated at a power in the range of about 1 Watt per linear foot to about 50 Watts per linear foot.

### CROSS REFERENCE TO RELATED APPLICATION

This application is a continuation of U.S. application Ser. No. 13/585,655, filed on Aug. 14, 2012, which is a continuation of U.S. application Ser. No. 12/437,394, filed on May 7, 2009, which claims the benefit of U.S. Provisional Application Ser. No. 61/051,235, filed on May 7, 2008, the disclosure of each which is incorporated herein by reference in its entirety.

### FIELD OF THE INVENTION

This invention is generally related to the treatment of mushrooms and, more particularly, is related to the treatment of mushrooms to enhance their vitamin D content while preserving characteristics typically associated with fresh mushrooms.

### BACKGROUND OF THE INVENTION

Fresh-cut fruits and vegetables that are ready to be used by consumers with little or no additional processing (sometimes referred to as “ready-to-use” produce or “value-added” produce) constitute the fastest-growing segment of the fresh produce market. In the case of mushrooms, appearance and cleanliness are two major factors used by consumers in assessing the freshness or quality of the mushrooms. Unwashed mushrooms historically have shown better long-term storage characteristics than washed mushrooms. However, to fit the definition of ready-to-use produce, mushrooms typically require washing to remove surface debris prior to their use. It would be desirable to treat washed mushrooms so as to preserve characteristics typically associated with fresh mushrooms.

Vitamin D refers to a group of organic substances involved in mineral metabolism and bone growth. Vitamin D can occur in various forms, including as hormones or prohormones such as Vitamin D₂ (e.g., ergocalciferol or calciferol) and metabolites or analogues thereof. Vitamin D has been implicated in cancer resistance, regulation of immune response, and prevention of disorders such as obesity. There are a limited number of natural, dietary sources of vitamin D, such as egg yolk, fish oil, and a few plants. Since natural diets typically do not include adequate quantities of vitamin D, consumption of dietary sources supplemented with vitamin D is desirable to prevent deficiencies. For example, milk is sometimes enriched with vitamin D. With sufficient exposure to sunlight, adequate blood levels of vitamin D can be produced in the skin. However, vitamin D deficiency remains a major nutritional concern in geographical areas that receive little sun, particularly during the winter months. It would be desirable to provide a dietary source of vitamin D and, in particular, to treat mushrooms so as to enhance their vitamin D content.

It is against this background that a need arose to develop the treatment for mushrooms described herein.

### SUMMARY OF THE INVENTION

Embodiments of the invention include the treatment of mushrooms to enhance their vitamin D content while preserving characteristics typically associated with fresh mushrooms. Embodiments of the invention also include mushrooms having enhanced vitamin D content and having characteristics typically associated with fresh mushrooms.

Other aspects and embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates measurements of vitamin D₂ content of whole portabella mushrooms that were exposed to ultraviolet (“UV”) radiation, according to an embodiment of the invention.

FIG. 2, FIG. 3, FIG. 4, and FIG. 5 illustrate color analysis on sliced mushrooms exposed to UV-B radiation against controls of sliced mushrooms that were not exposed to UV-B radiation, according to an embodiment of the invention.

### DETAILED DESCRIPTION

### Overview

Embodiments of the invention relate to improvements in the treatment of mushrooms to enhance their vitamin D content, enhance their shelf life, provide food safety, and preserve their appearance. In general, mushrooms that can benefit from these improvements include any commercially available mushrooms, such as white mushrooms, brown mushrooms, oyster mushrooms, and shitaki mushrooms, whether washed or unwashed, and whether whole or sliced. Certain embodiments of the invention are directed to treatment of washed and sliced mushrooms to provide ready-to-use produce having the advantages described herein.

By way of overview, certain embodiments of the invention relate to the treatment of mushrooms via the following operations, which are further described herein. It should be recognized that certain of the following operations can be omitted, combined, sub-divided, or re-ordered.
(1) Mushrooms undergo a wash process;
(2) Mushrooms are sliced;
(3) Mushrooms are exposed to UV radiation;
(4) Mushrooms are cooled in a cooling tunnel; and
(5) Mushrooms are packaged and stored in a cold environment.

### DEFINITIONS

The following definitions apply to some of the elements described with regard to some embodiments of the invention. These definitions may likewise be expanded upon herein.

As used herein, the singular terms “a,” “an,” and “the” include plural referents unless the context clearly dictates otherwise. Thus, for example, reference to an element can include multiple elements unless the context clearly dictates otherwise.

As used herein, the term “set” refers to a collection of one or more elements. Elements of a set can also be referred to as members of the set. Elements of a set can be the same or different. In some instances, elements of a set can share one or more common characteristics.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

As used herein, the term “fresh mushroom” refers to a mushroom that retains a set of physical characteristics substantially comparable to those present at harvest.

As used herein, the term “freshness” refers to a condition that is substantially comparable to that present at harvest. In some instances, freshness can refer to a condition that is acceptable to a consumer, such as a shopper at a retail location. Such condition can be established by customer satisfaction surveys or by quantitative standards, such as those set out in the Examples that follow.

As used herein, the term “substantially uncontrolled atmosphere” refers to one in which there is a substantial absence of a control process for respiration gases, other than that which can result from misting or other wetting or from refrigeration. In such substantially uncontrolled atmosphere, levels of carbon dioxide and oxygen can be substantially comparable to levels present in the earth's normal atmosphere, namely less than about 1% (by volume) of carbon dioxide and about 21% (by volume) of oxygen. At a retail location for mushrooms, surrounding conditions may increase carbon dioxide level and reduce oxygen level to some extent, and it is contemplated that a substantially uncontrolled atmosphere encompasses such typical variations.

As used herein, the term “modified atmosphere” refers to one in which either of, or both, an oxygen level and a carbon dioxide level differ from that present in a substantially uncontrolled atmosphere or the earth's normal atmosphere. In some instances, a modified atmosphere can include less than about 21% (by volume) of oxygen and more than about 1% (by volume) of carbon dioxide. Optional control of Relative Humidity (“RH”) can include providing a relatively high RH (e.g., at or above 87%) and the substantial absence of free liquid water (e.g., water in the form of a mist or suspended droplets).

As used herein, the term “respiration gases” refers to either of, or both, carbon dioxide and oxygen, the former being generated by respiration, and the latter being consumed. Water (in the form of water vapor) can also be generated by respiration. However, as used herein, the control of respiration gases need not involve control over water vapor.

As used herein, the term “container” refers to any object capable of holding or retaining another object, such as a set of mushrooms. A container can have an internal volume larger than a volume of mushrooms stored in the container. As such, there can be a range of relative proportion of a “mushroom storage volume,” which is a portion of the internal volume in which the mushrooms are located when the container is in a normal storage position, relative to a “void volume,” which is a portion of the internal volume substantially devoid of the mushrooms when the container is in the normal storage position.

As used herein, the term “hole” refers to a channel or passageway that permits flow of one or more of the following: oxygen; carbon dioxide; and water vapor. A hole can be a physical opening or perforation formed in a solid material, such as by cutting, plastic molding, or any other suitable process, or can be a pore of a porous or semi-porous membrane. In some instances, a hole can be formed in a wall of a container to provide for gas exchange between an interior and an exterior of the container.

### Wash Process

Certain embodiments of the invention can be used in conjunction with a wash process for the treatment of washed mushrooms. In general, a wash process refers to a set of operations to substantially remove surface debris from mushrooms after harvesting. In some instances, the mushrooms can be subjected to an aqueous wash process using a set of aqueous solutions, such as including a set of agents to assist in dirt removal, preservation, bacterial suppression, or the like. An aqueous solution can include pure water or water containing dissolved or suspended agents used in a wash process. Other examples of aqueous solutions include suspensions, emulsions, and other water mixtures.

An example of a wash process is described below, although it should be recognized that other wash processes can also be used. The wash process described herein is desirable, since it can provide preservation characteristics in addition to washing. Further details related to this wash process can be found in U.S. Pat. No. 6,500,476, issued on Dec. 31, 2002, the disclosure of which is incorporated herein by reference in its entirety.

According to an embodiment of the invention, a wash process includes: (1) contacting mushrooms with an aqueous anti-microbial solution having a pH from about 10.5 to about 12.5, such as from about 10.5 to about 11.5; (2) contacting the mushrooms one or more times with an aqueous pH neutralizing buffer solution that includes an organic acid and a salt of an organic acid, wherein the solution is substantially free from erythorbic acid and sodium erythorbate; and (3) contacting the mushrooms one or more times with a solution that includes a browning inhibitor and a chelating agent.

Advantageously, the wash process can be viewed as including three distinct operational stages: (1) an anti-microbial stage; (2) a neutralization stage; and (3) an anti-browning stage. In the first stage, the wash process uses a high pH solution as an anti-microbial treatment for whole or sliced mushrooms. This treatment can significantly reduce microbial load and associated bacterial decay and browning of mushroom tissue. To reduce damage of mushroom cap tissue from exposure to the high pH solution, the wash process includes a neutralization stage that is performed following exposure to the high pH solution. The wash process also includes an anti-browning stage to address enzymatic browning. The anti-browning stage can incorporate an anti-browning solution including an anti-oxidant or browning inhibitor, such as calcium, to maintain cellular tissue and to enhance browning inhibition. Ethylenediaminetetraacetic acid (“EDTA”) can be used to provide further browning inhibition. By separating the neutralization stage and the anti-browning stage, the wash process can be more cost effective by reducing depletion of the relatively expensive anti-browning solution.

More particularly, the anti-microbial stage of the wash process can involve contacting mushrooms with an anti-microbial buffer solution having a pH from about 10.5 to about 11.5. A wide variety of compounds can be used alone, or in combination, in this solution to attain the desired pH, such as sodium bicarbonate, sodium carbonate, and sodium hydroxide. In some instances, a combination of sodium bicarbonate and sodium carbonate is desirable. About 0.3% to about 0.5% (by weight) of sodium bicarbonate and about 0.05% to about 0.10% (by weight) of sodium carbonate can be particularly satisfactory. In some instances, an initial contact with the anti-microbial buffer solution can be carried out for about 20 to about 40 seconds at an ambient temperature of about 25° C. Somewhat elevated temperatures can be used to provide greater anti-microbial action, but these elevated temperatures can permit lower dwell times in solution.

Next, the mushrooms can be contacted one or more times with at least one aqueous pH neutralizing buffer solution including an organic acid and a salt of an organic acid, while being substantially free from erythorbic acid and sodium erythorbate. This neutralization stage is carried out to reduce the pH of the mushrooms to a substantially normal pH, and can be accomplished by applying the buffer solution via any conventional techniques, such as by dipping, spraying, or cascading. In some instances, the buffer solution has a pH of about 3.0 to about 5.0. Acids and bases used for preparation of the salt can be weak acids and bases, such as citric acid and sodium citrate. For example, a 0.1 N solution of citric acid, having a pH of about 3.5, can be used effectively. Other examples of organic acids include malic, acetic, phosphoric, and lactic acids. Contacting time can vary, for example, with the pH of the mushrooms after the anti-microbial stage and volume of the buffer solution, and can range from about 10 to about 30 seconds.

The anti-browning stage of the wash process can involve treating the mushrooms one or more times with at least one solution including a browning inhibitor and a chelating agent. A wide variety of browning inhibitors can be used to retard the effect of tyrosinase. These browning inhibitors include reducing agents, such as sodium erythorbate, erythorbic acid, ascorbic acid, and calcium ascorbate. A wide variety of chelating agents that have a high affinity for copper can be used. These can include, for example, polyphosphates such as sodium hexametaphosphate and others currently approved for use on fruits and vegetables and that are categorized by the Food and Drug Administration as Generally Recognized As Safe (“GRAS”). Calcium disodium EDTA can also be particularly satisfactory for certain applications. In some embodiments, the solution used in the anti-browning stage can also include calcium chloride.

In some instances, the pH of individual solutions can be monitored for the purpose of maintaining an optimum pH. Also, the concentration of sodium erythorbate can be monitored for enhancing inhibition of enzymatic browning of mushrooms.

For certain applications, the wash process can be implemented as a continuous process in which mushrooms are introduced into a first wash stage and conveyed through each subsequent stage with reduced damage, reduced browning, and reduced depletion of active ingredients. Solutions of sodium bicarbonate and sodium carbonate can be adjusted with sodium hydroxide to achieve a high pH in the first stage and maintained at a temperature of at least about 25° C. After the first stage, the pH of the mushrooms can be rapidly adjusted to about 6.5, which is more physiologically acceptable for the mushrooms. This rapid reduction in pH can be accomplished during a second stage of the process or as part of a rinsing operation. The rinsing operation can occur in a tank that contains a citrate buffer made from an organic acid and a salt of an organic acid and that is at ambient temperature. To reduce uptake of solution, the mushrooms can remain in the second stage for no more than about 10 to about 30 seconds. The mushrooms can then be transported by a conveyor to a third stage. A solution used in the third stage can be maintained at ambient temperature and can include sodium erythorbate, calcium chloride, and EDTA as a treatment for enzymatic browning. The mushrooms can remain in this solution for about 20 to about 40 seconds. The total exposure time during the three stage process can be limited to about 50 to about 110 seconds.

### Slicing of Mushrooms

Certain embodiments of the invention can be used in conjunction with slicing of mushrooms, such as after the mushrooms undergo a wash process. In general, slicing refers to a set of operations to cut mushrooms after harvesting. In some instances, the mushrooms can be cut into smaller pieces, such that an interior of a mushroom cap or stem is exposed at a location other than an initial point where the mushroom cap or stem was separated from a mushroom bed. Slicing of mushrooms can occur after washing, although additional washing operations can also occur afterwards. In some instances, slicing of mushrooms is considered to occur after washing when at least one aqueous washing operation occurs prior to the slicing.

Slicing of mushrooms can be performed in various ways, such as using a grate or a Wakker slicer (Dutch Tech-Source), to produce sliced mushrooms having a thickness of about ⅛ inch to about 1 inch, such as from about ⅛ inch to about ½ inch or from about ¼ inch to about 5/16 inch. In addition to the relatively large pieces resulting from slicing, smaller pieces in the form of trimmings and other by-products in the form of stumps can be subjected to further operations as described herein.

### Exposure of Mushrooms to UV Radiation

Certain embodiments of the invention can be used in conjunction with exposure of mushrooms to UV radiation, such as after the mushrooms undergo a wash process and slicing. In particular, it can be desirable to irradiate the mushrooms with UV radiation so as to enhance their vitamin D₂ content. In addition, irradiation of the mushrooms with UV radiation can provide preservation characteristics and, thereby, prolong the shelf life of the mushrooms.

Without wishing to be bound by a particular theory, it is believed that exposure of mushrooms to UV radiation promotes the conversion of ergosterol within the mushrooms to vitamin D₂. UV radiation that can be used include UV-A (e.g., long wavelengths in the range of about 315 nm to about 400 nm), UV-B (e.g., medium wavelengths in the range of about 280 nm to about 315 nm), UV-C (e.g., short wavelengths in the range of about 100 nm to about 280 nm), and combinations thereof. For some embodiments, UV-B, or a combination of UV-B as a substantial fraction and UV-A as a minor fraction, is particularly desirable, since such wavelengths are effective in enhancing vitamin D₂ content, while being safer and avoiding or reducing darkening of mushrooms that can otherwise result when irradiating with shorter wavelengths, such as UV-C. In particular, UV radiation with a peak intensity in the range of about 300 nm to about 330 nm, such as from about 310 nm to about 320 nm or from about 310 nm to about 315 nm, can achieve a desired enhancement of vitamin D₂ content, while being safer from both a processing standpoint and a consumption standpoint by avoiding or reducing chemical, mutational, or other alterations of the mushrooms. It is contemplated, however, that UV-C can be used in place of, or in combination with, UV-B. In particular, UV-C is germicidal, and can be advantageously used to provide an enhanced anti-microbial effect.

For some embodiments, a dose or energy level of UV radiation is desirably in the range of about 0.02 J/cm² to about 1.5 J/cm², such as from about 0.02 J/cm² to about 0.5 J/cm², from about 0.02 J/cm² to about 0.2 J/cm², from about 0.02 J/cm² to about 0.15 J/cm², or from about 0.05 J/cm² to about 0.15 J/cm². Such dose level is effective in enhancing vitamin D₂ content, while being safer and avoiding or reducing darkening of mushrooms that can otherwise result when irradiating at higher dose levels. To achieve a desirable dose level, an UV source can be implemented as a set of rows, such as a set of rows of UV fluorescent lamps, and each of the rows can operate at a power in the range of about 1 Watt per linear foot to about 50 Watts per linear foot, such as from about 5 Watts per linear foot to about 25 Watts per linear foot or from about 10 Watts per linear foot to about 20 Watts per linear foot. When activated, the UV source desirably emits UV radiation in a substantially continuous fashion, rather than, for example, in a pulsed fashion. Use of such a continuous and fluorescent UV source provides a number of advantages, including enhanced safety and greater ease and flexibility for the treatment of mushrooms. It is contemplated, however, that a pulsed UV source can be used in place of, or in combination with, a continuous UV source.

Exposure time for UV radiation can be selected based on various factors, including a desired vitamin D₂ content, a dose level of the UV radiation, and whether mushrooms exposed to the UV radiation are sliced mushrooms or whole mushrooms. For some embodiments, sliced mushrooms are particularly desirable, since their use can significantly reduce the exposure time for UV radiation while achieving a desired enhancement of vitamin D₂ content for a particular dose level of the UV radiation. A reduced exposure time can be desirable for reducing time and cost associated with the treatment of mushrooms as well as reducing negative impact on their appearance and undesirable alterations when exposed to UV radiation for a prolonged period of time. Without wishing to be bound by a particular theory, it is believed that surface area effects provide at least some of the benefits of sliced mushrooms relative to whole mushrooms. For some embodiments, the exposure time can be in the range of about 1 second to about 15 minutes. In the case of sliced mushrooms, the exposure time can be less than about 40 seconds, such as from about 1 second to about 35 seconds, from about 1 second to about 30 seconds, from about 5 seconds to about 30 seconds, from about 5 seconds to about 25 seconds, from about 5 seconds to about 20 seconds, or from about 5 seconds to about 10 seconds. In the case of whole mushrooms, the mushrooms are desirably oriented with their gills facing the UV radiation, although at least some of the mushrooms can be oriented with their gills facing away from the UV radiation.

Vitamin D₂ content of resulting mushrooms can be expressed in terms of quantities of International Unit (“IU”), where one IU corresponds to 0.025 μg of vitamin D₂. A serving size can be assumed to be 84 g of the resulting mushrooms, and the current recommended Daily Value of vitamin D₂ is 400 IU (or 10 μg). For some embodiments, vitamin D₂ content of one serving size of the resulting mushrooms can be at least a substantial fraction of the recommended Daily Value, such as at least about 20%, at least about 50%, at least about 80%, or at least about 90% of the recommended Daily Value, and up to about 100% or more of the recommended Daily Value. In some instances, vitamin D₂ content of one serving size of the resulting mushrooms can be equal to or greater than the recommended Daily Value, such as equal to or greater than about 1.5 times, about 2 times, about 3 times, or about 10 times the recommended Daily Value, and up to about 65 times or more of the recommended Daily Value. For some embodiments, the vitamin D₂ content can be in the range of about 18,000 to about 26,000 IU per serving size when exposed to UV-B radiation at a dose level of about 1 Joule/cm². The resulting mushrooms can retain enhanced levels of vitamin D₂ over their shelf life. Accordingly, a consumer can receive at least a substantial fraction of the recommended Daily Value of vitamin D₂ in a single serving of the resulting mushrooms even at the end of their shelf life. For some embodiments, the shelf life can be assumed to be about 10 days or less, and the resulting mushrooms can retain at least a substantial fraction of their initial vitamin D₂ content after exposure to UV radiation, such as at least about 30%, at least about 50%, at least about 60%, or at least about 70% of their initial vitamin D₂ content. For example, the resulting mushrooms can have an initial vitamin D₂ content in the range of about 400 to about 1,000 IU per serving size, such as from about 500 to about 900 IU per serving size or from about 600 to about 800 IU per serving size, so as to retain about 100% of the recommended Daily Value of vitamin D₂ in a single serving at the end of their shelf life.

In addition to enhancement of vitamin D₂ content, exposure to UV radiation can provide other improvements in terms of preserving freshness and prolonging shelf life. In particular, over the course of their shelf life, the resulting mushrooms can exhibit less darkening or discoloration relative to mushrooms that are not exposed to UV radiation. Darkening can be expressed in terms of L* parameter, which represents a brightness parameter that extends from 0 (black) to 100 (white). For some embodiments, the shelf life can be assumed to be about 10 days or less, and the resulting mushrooms can retain at least a substantial fraction of their initial brightness parameter value after exposure to UV radiation, such as at least about 70%, at least about 80%, at least about 90%, or at least about 95% of their initial brightness parameter value. Without wishing to be bound by a particular theory, it is believed that exposure of mushrooms to UV radiation can promote one or more of the following: (1) a denaturing effect of the UV radiation on enzymes that cause browning; (2) a direct anti-microbial effect of the UV radiation; (3) drying of surfaces of the mushrooms during the exposure that results in less bacterial growth and less enzymatic browning; and (4) cauterization or sealing of the surfaces of the mushrooms.

In addition to the relatively large pieces resulting from slicing of mushrooms, smaller pieces in the form of trimmings and other by-products in the form of stumps can be exposed to UV radiation as described herein. Because of their smaller size, these smaller pieces can exhibit enhanced absorption rate of the UV radiation and enhanced conversion rate to vitamin D₂, relative to larger pieces or whole mushrooms. When exposed to UV radiation, these smaller pieces can build up relatively large quantities of vitamin D₂, without concern for discoloration resulting from prolonged exposure to the UV radiation. The resulting material can be preserved through freezing or freeze drying, and used as a flavoring additive, food additive, or dietary supplement.

### Cooling, Packaging, and Storage of Mushrooms

Certain embodiments of the invention can be used in conjunction with cooling, packaging, and storage of mushrooms, such as after the mushrooms undergo a wash process, slicing, and exposure to UV radiation. In particular, it can be desirable to cool the mushrooms following their exposure to UV radiation so as to reduce any damage that might otherwise result from the exposure and to return the mushrooms to a physiologically desirable temperature, such as at or below ambient temperature. Cooling of the mushrooms can be performed in various ways, such as using a cooling tunnel or a blast cooler.

Next, the mushrooms can be packaged and stored in a refrigerated setting, such as in a cold room or a refrigerated display at a retail location. An example of a technique for packaging and storage of mushrooms is described below, although it should be recognized that other techniques can also be used. The technique described herein is desirable, since it can extend freshness of mushrooms. Further details related to the technique can be found in U.S. Patent Application Publication No. 2008/0093241, published on Apr. 24, 2008, the disclosure of which is incorporated herein by reference in its entirety.

In particular, packaging and storage of mushrooms can be implemented to provide a modified atmosphere in contact with or surrounding the mushrooms. This modified atmosphere can involve a reduced level of oxygen and an elevated level of carbon dioxide relative to those present in a substantially uncontrolled atmosphere or the earth's normal atmosphere. For example, this modified atmosphere can include an oxygen level within a range of about 10% to about 20% (by volume), such as from about 14% to about 18% or from about 15% to about 17%, and a carbon dioxide level within a range of about 2.5% to about 12% (by volume), such as from about 5% to about 9% or from about 6% to about 8%. Optionally, this modified atmosphere can also involve controlling a RH to be in a range of about 87% to about 100%, such as from about 88% to about 94% or from about 88% to about 92% (in the substantial absence of free liquid water).

A modified atmosphere can be provided in various ways. In some embodiments, containers in the form of flexible storage bags or hard clam-shell packagings can be used to provide the desired modified atmosphere. This can be achieved by controlling gas flow into and out of a container by using a set of holes, by using a set of permeable or semi-permeable membranes, or both. In other embodiments, mushrooms can be sold loose so that customers can select a desired amount of mushrooms. For these embodiments, the mushrooms can be positioned in a container with a lid that automatically closes, with a modified atmosphere being pumped into the container from a compressed gas tank or from an atmospheric extraction device to maintain the desired modified atmosphere.

For example, a container can be implemented to achieve a steady-state, modified atmosphere by providing a set of holes to control the rate of gas exchange between an interior of the container and an ambient atmosphere surrounding the container. An atmosphere inside the container typically starts with normal oxygen and carbon dioxide levels and the RH of an ambient atmosphere at which mushrooms are placed into the container. The atmosphere inside the container then typically changes over time as the mushrooms respire, with the level of oxygen decreasing and the levels of carbon dioxide and water vapor increasing. Concentration gradients can develop between the interior of the container and the ambient atmosphere. These concentration gradients on two sides of the holes can cause respiration gases to diffuse through the holes. In particular, oxygen can enter to replace what has been used up by cellular respiration, while carbon dioxide and water vapor, which have accumulated as a result of cellular respiration, can exit. Eventually, steady-state levels of respiration gases can be reached inside the container, with specific levels depending on the amount of the mushrooms present to produce and use up respiration gases and an area of the holes to allow gas exchange.

To achieve desired oxygen and carbon dioxide levels while maintaining a high RH in the substantial absence of free liquid water, a container for storage of mushrooms is typically perforated. For example, holes in the form of physical openings can be provided in a container that would otherwise restrict water vapor movement and exchange of oxygen and carbon dioxide with an ambient atmosphere. The holes can provide for sufficient replenishment of oxygen and discharge of carbon dioxide to avoid anaerobic conditions. Control of a total hole area by selecting the number and size of the holes can allow appropriate steady-state conditions to be reached. The desired steady-state conditions can also be achieved by using a permeable or semi-permeable membrane in combination with the holes.

With regard to location, size, and number of holes formed in a container, a range of variations can be used to provide satisfactory results in terms of a substantially even diffusion of respiration gases. In some instances, a hole pattern can be formed in a wall or multiple walls of a container, such that there is gas exchange between most or all interior portions of the container and an ambient atmosphere. The holes can be substantially uniformly spaced around the container. However, such uniform spacing is not required in all applications. Indeed, a range of hole patterns can be used, since diffusion of respiration gases can be relatively rapid and can account for variations in spacing of holes. In particular, a concentration gradient can develop to facilitate internally generated respiration gases to diffuse to certain ones of the holes that are located further away, while oxygen can diffuse inwardly in a similar manner. Thus, a series of holes along a line in a wall of a container (or along several lines spaced apart from each other) can provide adequate uniformity of gas exchange. Such lines of holes can be relatively easy to manufacture when the container is, for example, a flexible film storage bag. On the other hand, holes spaced in a two-dimensional array on a surface can also be satisfactory, and can be readily manufactured by a number of techniques. Many satisfactory hole patterns can space a set of holes such that a distance from any mushroom to a nearest hole is no greater than about one third of a characteristic dimension (e.g., a length) of a container, such as no more than about one fourth or one fifth of the characteristic dimension. In some instances, absolute distances between a mushroom and a nearest hole can be less than about 60 mm, such as less than about 40 mm or less than about 20 mm. These distances can be maintained while varying a shape of a container or a weight of mushrooms present. In the case of larger distances, specific arrangement of interior geometry and free gas volumes (e.g., by providing shelves in a large container to provide layers of mushrooms with spaces between layers) can also yield satisfactory results.

In the absence of a forced exchange, gas exchange between an interior and an exterior of a container typically occurs via diffusion. It should be noted, however, that changing temperature and pressure can cause some expansion or contraction of an interior volume of the container, thereby creating conditions similar to a forced exchange. For some embodiments, a forced-air-flow measurement technique can be used to select a hole pattern to provide desired overall diffusion rates. An estimate of a diffusion rate satisfactory for the practice of some embodiments of the invention can be determined by measuring a rate of air flow into or out of a container with a given hole pattern and under specified pressure conditions. This flow rate can take into consideration a weight of mushrooms that will be present in the container, as larger amounts of mushrooms can produce larger amounts of respiration gases and, thus, can require a larger hole area to handle a higher diffusion rate. Using a pressure differential between an interior of a container and an ambient atmosphere of 5 inches of water (1 inch of water=2.49089×10² Pa), satisfactory results can be achieved with a flow rate in the range of about 0.2 to about 0.6 Standard Cubic Foot per Hour (“SCFH”) per ounce of mushrooms, such as from about 0.3 to about 0.45 SCFH per ounce of mushrooms. As can be recognized, SCFH is defined relative to a Standard Cubic Foot (“SCF”), which is one cubic foot of air at standard conditions of temperature and pressure (i.e., 1 atmosphere and 20° C.).

In some embodiments of the invention, a combination of size, number, and location of a set of holes can be selected to achieve a desired steady-state, modified atmosphere. In one such embodiment, a number and size of the holes can be selected to provide from about 0.05 to about 1.5 mm² of open area per ounce of mushrooms, such as from about 0.08 to about 0.20 mm² or about 0.125 mm² (+/−10%) of open area per ounce of mushrooms. A range of one to six holes per ounce of mushrooms, with each hole having a characteristic dimension (e.g., diameter) from about 150 to about 600 μm, can be located in a set of walls of a container. In a container designed for retail purposes, a set of holes can be located, at least in part, in a header area away from mushrooms to create a gradient of high to low RH. This gradient provides desired water vapor transmission and maintains a desired RH surrounding the mushrooms. However, a set of holes can also be located near the mushrooms, particularly in the case of a larger container where a void volume can be at a distance from the mushrooms at a bottom of the container. This combination of size and number of holes per unit weight of mushrooms (along with their location) can allow desired levels of oxygen, carbon dioxide, and RH to develop in a void volume (e.g., a headspace) of the container during storage. Diffusion within the container can ensure relatively even levels of oxygen, carbon dioxide, and RH throughout the container.

Table 1 below sets forth design parameters for containers implemented in accordance with some embodiments of the invention:

TABLE 1

| | |
|---|---|
| Hole dimension | 1150-600 μm or 200-300 μm |
| (e.g., diameter if round): | |
| Hole dimensions (e.g., | 150 × 200-300 μm or 150 × 250 μm |
| width × length if oblong): | (max. ratio of 2.0 for length to width ratio) |
| No. of holes/oz of | 2-4 or 2-2.5 |
| mushrooms: | |
| Flow rate per hole: | 0.15-0.30 SCFH at a pressure of 5 inches of |
| | water |
| Flow rate per bag: | 2.0-18 SCFH at a pressure of 5 inches of |
| | water |
| Flow rate per oz of | 0.2-0.6 SCFH or 0.3-0.45 SCFH at a |
| mushrooms: | pressure of 5 inches of water |

### EXAMPLES

The following examples describe specific aspects of some embodiments of the invention to illustrate and provide a description for those of ordinary skill in the art. The examples should not be construed as limiting the invention, as the examples merely provide specific methodology useful in understanding and practicing some embodiments of the invention.

### Example 1

Effectiveness of exposure to UV-B radiation was determined by measuring vitamin D₂ content of both whole and sliced portabella mushrooms that were exposed to UV-B radiation at different dose or energy levels. Vitamin D₂ content was measured in terms of quantities of IU, where one IU corresponds to 0.025 μg of vitamin D₂. Whole mushrooms were exposed to UV-B radiation with gills facing the radiation (i.e., gill-side) and with gills facing away from the radiation (i.e., button-side). Sliced mushrooms had a thickness of about 5/16 inch, and were spread out in a single layer and then exposed on one side. Results are set forth in the following Table 2. The serving size is assumed to be 84 g of mushrooms having 91.06% moisture content, and the Daily Value (“DV”) of vitamin D₂ is assumed to be 400 IU (or 10 μg). As can be recognized from Table 2, both whole and sliced mushrooms exhibited enhanced vitamin D₂ content when exposed to UV-B radiation. However, enhancement of vitamin D₂ content was particularly pronounced in sliced mushrooms, which had a vitamin D₂ content in the range of about 18,000 to about 26,000 IU per serving size when exposed to UV-B radiation. Vitamin D₂ content in the resulting mushrooms was dependent upon dose level of UV-B radiation in the range of about 0.5 to about 1.5 Joule/cm².

TABLE 2

| | | | |
|---|---|---|---|
| | IU/g dry | | |
| Product | substrate | IU/serving | % DV (10 μg) |

0.5 J/cm²

| | | | |
|---|---|---|---|
| Button-Side | 301.2 | 2260 | 565.0 |
| Gill-Side | 453.2 | 3401.2 | 850.3 |
| Sliced | 2400 | 18020 | 4504.7 |

0.75 J/cm²

| | | | |
|---|---|---|---|
| Button-Side | 371.2 | 2785.6 | 696.4 |
| Gill-Side | 527.2 | 3956.8 | 989.2 |
| Sliced | 2370 | 17792 | 4448.4 |

1.0 J/cm²

| | | | |
|---|---|---|---|
| Button-Side | 413.2 | 3100.8 | 775.2 |
| Gill-Side | 661.2 | 4964 | 1240.7 |
| Sliced | 2570 | 19296 | 4823.8 |
| Button-Side | 419.2 | 3044.4 | 761.1 |
| | 415.2 | 3015.2 | 753.8 |
| Button-Side | 478 | 3588.8 | 897.2 |
| Gill-Side | 625.2 | 4692 | 1173.1 |
| Sliced | 3180 | 23876 | 5968.7 |

1.5 J/cm²

| Product | IU/g d.s. | IU/serving* | % DV (10 μg) |
|---|---|---|---|
| Button-Side | 509.2 | 3821.6 | 955.4 |
| Gill-Side | 947.2 | 7108 | 1777.5 |
| Sliced | 2890 | 21696 | 5424.4 |

### Example 2

Impact of exposure to UV-B radiation was determined by performing color analysis on whole brown mushrooms exposed to UV-B radiation against a control of whole mushrooms that were not exposed to UV-B radiation. Color analysis was performed using a colorimeter, with measurements of L* parameter, which represents a brightness parameter that extends from 0 (black) to 100 (white), b* parameter, which represents a yellow-blue chromaticity (with positive values corresponding to intensity in yellow, and negative values corresponding to intensity in blue), and a* parameter, which represents a red-green chromaticity (with positive values corresponding to intensity in red, and negative values corresponding to intensity in green). Results are set forth in the following Table 3. As can be recognized from Table 3, exposure to UV-B radiation was sometimes observed to produce a darkening of mushrooms, but the amount of darkening was relatively slight and remained relatively constant over a 1 day interval.

TABLE 3

| | | |
|---|---|---|
| L* | a* | b* |

Mushroom Sample 1

| | | | |
|---|---|---|---|
| Before Treatment | 48.40 | 9.37 | 20.74 |
| After Treatment: | | | |
| Shortly afterwards | 47.25 | 9.98 | 19.45 |
| 30 min. | 47.12 | 9.41 | 17.83 |
| 1 Day | 47.20 | 9.26 | 18.39 |

Mushroom Sample 2

| | | | |
|---|---|---|---|
| Before Treatment | 47.90 | 10.23 | 20.70 |
| After Treatment: | | | |
| Shortly afterwards | 46.77 | 10.00 | 19.71 |
| 30 min. | 46.28 | 9.12 | 19.00 |
| 1 Day | 45.99 | 10.22 | 18.68 |

Mushroom Sample 3

| | | | |
|---|---|---|---|
| Before Treatment | 52.01 | 11.56 | 25.75 |
| After Treatment: | | | |
| Shortly afterwards | 52.69 | 10.86 | 24.12 |
| 30 min. | 52.69 | 10.86 | 24.06 |
| 1 Day | 50.80 | 11.18 | 22.47 |

Mushroom Sample 4

| | | | |
|---|---|---|---|
| Before Treatment | 50.03 | 12.28 | 24.76 |
| After Treatment: | | | |
| Shortly afterwards | 51.44 | 11.25 | 24.15 |
| 30 min. | 50.27 | 11.65 | 23.31 |
| 1 Day | 49.30 | 11.20 | 21.39 |

Control Samples (no treatment)

| | | | |
|---|---|---|---|
| Sample a (time = 0) | 48.50 | 12.01 | 23.16 |
| Sample b (time = 0) | 48.67 | 9.57 | 20.41 |
| Sample a (time = 1 Day) | 48.55 | 12.66 | 24.33 |
| Sample b (time = 1 Day) | 49.60 | 9.71 | 20.45 |

### Example 3

Impact of exposure to UV-B radiation was determined by performing color analysis on sliced mushrooms prior to and subsequent to the exposure. Color analysis was performed using a colorimeter, with measurements of L* parameter, b* parameter, and a* parameter. Results are set forth in the following Table 4. As can be recognized from Table 4, exposure to UV-B radiation was observed to produce a slight darkening of mushrooms.

TABLE 4

| | | |
|---|---|---|
| L* | a* | b* |

Sliced (no treatment)

| | | | |
|---|---|---|---|
| Sample a | 84.40 | 1.40 | 11.76 |
| Sample b | 87.12 | 0.82 | 10.94 |
| Sample c | 80.54 | 2.12 | 14.85 |

Sliced (shortly after treatment)

| | | | |
|---|---|---|---|
| Sample a | 75.40 | 3.86 | 16.82 |
| Sample b | 77.12 | 3.57 | 17.61 |
| Sample c | 77.51 | 6.24 | 17.06 |

### Example 4

Impact of exposure to UV-B radiation was determined by performing color analysis on mushrooms exposed to UV-B radiation against a control of sliced mushrooms that were not exposed to UV-B radiation. In particular, mushrooms were exposed to UV-B radiation as whole mushrooms, and then sliced. Color analysis was performed using a colorimeter, with measurements of L* parameter, b* parameter, and a* parameter. Results are set forth in the following Table 5.

TABLE 5

| | | |
|---|---|---|
| L* | a* | b* |

Control (sliced from untreated whole mushrooms)

| | | | |
|---|---|---|---|
| Sample 1 | 87.46 | 0.32 | 12.31 |
| Sample 2 | 87.53 | 0.26 | 12.98 |
| Sample 3 | 87.86 | −0.01 | 12.82 |
| Sample 4 | 85.72 | −0.11 | 12.31 |
| Sample 5 | 88.45 | −0.32 | 13.42 |
| Sample 6 | 86.28 | 0.29 | 13.06 |
| Sample 7 | 87.82 | −0.43 | 13.63 |
| Sample 8 | 88.85 | −1.15 | 12.74 |

Sliced Mushrooms (sliced after 10 min. from
treated whole mushrooms)

| | | | |
|---|---|---|---|
| Sample 9 | 85.71 | 0.35 | 13.78 |
| Sample 10 | 89.86 | −0.72 | 12.71 |
| Sample 11 | 87.24 | −0.07 | 12.81 |
| Sample 12 | 88.81 | −0.21 | 11.97 |
| Sample 13 | 87.55 | −0.09 | 11.73 |
| Sample 14 | 89.18 | −0.06 | 11.88 |
| Sample 15 | 86.60 | −0.12 | 11.83 |
| Sample 16 | 88.37 | −0.32 | 12.32 |

Sliced Mushrooms (sliced after 1 Day from
treated whole mushrooms)

| | | | |
|---|---|---|---|
| Sample 17 | 89.71 | −0.05 | 10.28 |
| Sample 18 | 86.72 | 0.27 | 9.40 |
| Sample 19 | 88.67 | 1.23 | 11.99 |
| Sample 20 | 89.92 | −0.10 | 11.52 |
| Sample 21 | 88.12 | −0.08 | 9.05 |
| Sample 22 | 87.96 | 0.70 | 11.87 |
| Sample 23 | 89.65 | 0.26 | 11.24 |
| Sample 24 | 86.62 | 1.78 | 12.98 |

### Example 5

Effectiveness of exposure to UV-B radiation was determined with respect to moisture content of whole mushrooms prior to and subsequent to the exposure. Moisture content was expressed in terms of wet-basis (“wb”) moisture content, which represents a ratio of moisture weight to total weight. Whole mushrooms were exposed to UV-B radiation with gills facing the radiation (i.e., gill-side) and with gills facing away from the radiation (i.e., button-side). Results are set forth in the following Table 6. As can be recognized from Table 6, whole mushrooms exhibited a reduction of moisture content when exposed to UV-B radiation. This reduction of moisture content can prolong shelf life by inhibiting bacterial growth.

TABLE 6

| | | | | Moisture | Moisture |
|---|---|---|---|---|---|
| | Weight | | | Content | Content |
| | Before | Weight | Moisture | Before (% | After (% |
| | (g) | After (g) | Loss (g) | wb) | wb) |
| Button-Side | | | | | |
| Mushrooms | | | | | |
| Sample a | 20.56 | 20.41 | −0.15 | 91.39 | 91.33 |
| Sample b | 19.69 | 19.56 | −0.13 | 91.39 | 91.31 |
| Gill-Side | | | | | |
| Mushrooms | | | | | |
| Sample a | 22.86 | 22.70 | −0.16 | 91.15 | 91.10 |
| Sample b | 24.98 | 24.82 | −0.16 | 91.15 | 91.10 |

### Example 6

Effectiveness of exposure to UV-B radiation was determined by measuring vitamin D₂ content of mushrooms that were exposed to UV-B radiation. Vitamin D₂ content was measured shortly after and 10 days after exposure. Results are set forth in the following Table 7. As can be recognized from Table 7, mushrooms were observed to exhibit a decline in vitamin D₂ content over the course of 10 days. In the case of unwashed mushrooms and mushrooms that were washed prior to exposure to UV-B radiation, a substantial fraction of vitamin D₂ content was retained over the course of 10 days. In the case of mushrooms that were exposed to UV-B radiation and then washed, a greater decline in vitamin D₂ content was observed.

TABLE 7

| | Total | Difference | |
|---|---|---|---|
| | Vitamin | in | |
| | D (IU/ | Vitamin D | |
| | 100 g) | (IU/100 g) | Comment |
| Sample a (t = 0) | 25400 | | Mushrooms were not |
| Sample a (t = 10 days) | 20700 | −4700 | washed, but were exposed |
| | | | to UV radiation |
| Sample b (t = 0) | 27500 | | Mushrooms were exposed |
| Sample b (t = 10 days) | 675 | −26825 | to UV radiation and then |
| | | | washed using a high pH |
| | | | solution |
| Sample c (t = 0) | 23900 | | Mushrooms were washed |
| Sample c (t = 10 days) | 14300 | −9600 | and then exposed to UV |
| | | | radiation |

### Example 7

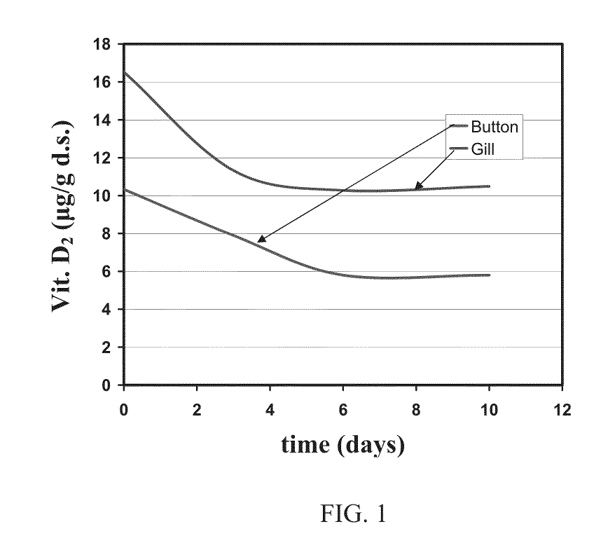

Effectiveness of exposure to UV-B radiation was determined by measuring vitamin D₂ content of whole portabella mushrooms that were exposed to UV-B radiation. Vitamin D₂ content was measured at different times after exposure. The mushrooms were exposed to UV-B radiation with gills facing the radiation (i.e., gill-side) and with gills facing away from the radiation (i.e., button-side). Results are set forth in the following Table 8, Table 9, and FIG. 1. The serving size is assumed to be 84 g of mushrooms having 91.4% moisture content. As can be recognized from Table 8, Table 9, and FIG. 1, the mushrooms were observed to exhibit a decline in vitamin D₂ content over the course of 10 days. However, retention of vitamin D₂ is expected to be sufficient over the shelf life of the mushrooms, such that a consumer would receive at least the recommended DV of vitamin D₂ in a single serving even at the end of the shelf life. In particular, after 10 days, the mushrooms still retained about 14,000 IU. The mushrooms were observed to lose about 40% of the initial level of vitamin D₂ through the first 6 days of shelf life, after which the decline levels off. It is expected that sliced mushrooms would behave in a similar manner.

TABLE 8

| | IU/g dry substrate | | | | |
|---|---|---|---|---|---|
| | | 1 Day | 3 Day | 6 Day | 10 Day |
| Product | Initial | Storage | Storage | Storage | Storage |
| Button-Side | 413.2 | 252 | 316 | 232 | 232 |
| Gill-Side | 661.2 | 480 | 453.2 | 411.2 | 410.96 |

TABLE 9

| | % DV/serving | | | | |
|---|---|---|---|---|---|
| | | 1 Day | 3 Day | 6 Day | 10 Day |
| Product | Initial | Storage | Storage | Storage | Storage |
| Button-Side | 744.1 | — | 569.4 | 418.0 | 418.0 |
| Gill-Side | 1191.0 | 864.9 | 816.2 | 740.5 | 749.5 |

### Example 8

Effectiveness of exposure to UV-C radiation was determined by measuring vitamin D₂ content of whole mushrooms that were exposed to UV-C radiation. The mushrooms were exposed to UV-C radiation with gills facing the radiation (i.e., gill-side) and with gills facing away from the radiation (i.e., button-side). Results are set forth in the following Table 10. The serving size is assumed to be 84 g of mushrooms. As can be recognized from Table 10, the mushrooms exhibited enhanced vitamin D₂ content when exposed to UV-C radiation.

TABLE 10

| | IU/g dry | | % |
|---|---|---|---|
| Product | substrate | IU/serving | DV/serving |
| White button, button-side, 5 min | 552 | 3478 | 869.4 |
| White button, button-side, 15 min | 576 | 3251 | 812.7 |
| Portabella, gill-side, 5 min | 300 | 1890 | 472.5 |
| Portabella, gill-side, 15 min | 496 | 3125 | 781.2 |

### Example 9

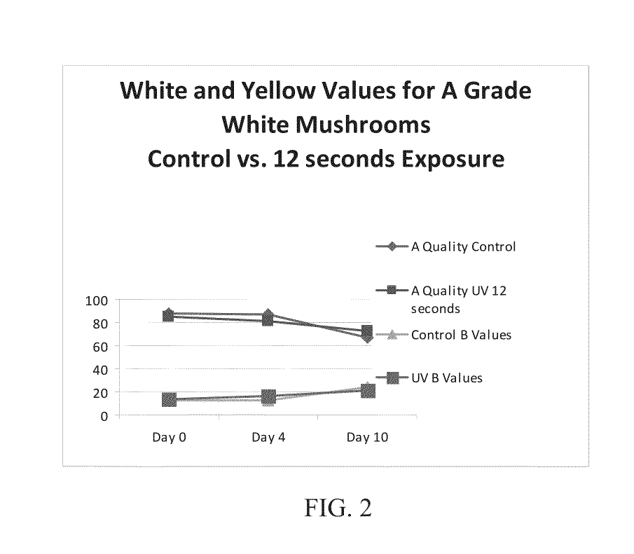

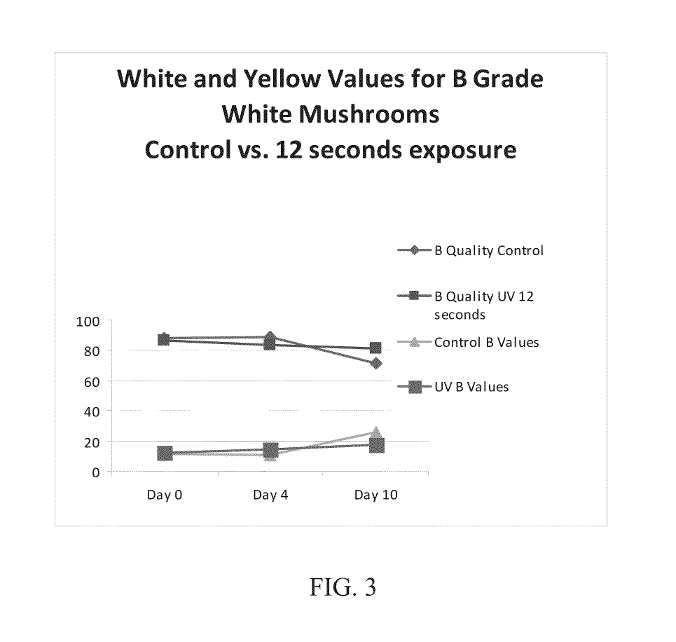

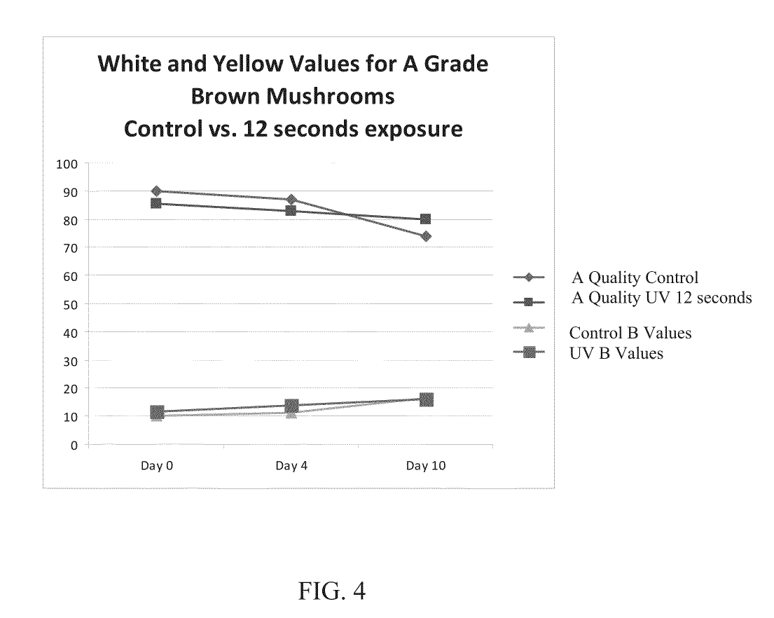

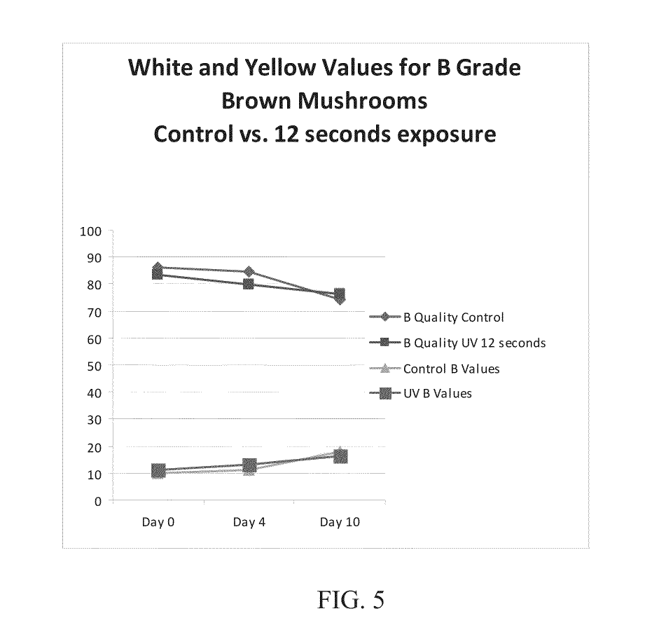

Impact of exposure to UV-B radiation was determined by performing color analysis on sliced mushrooms exposed to UV-B radiation against controls of sliced mushrooms that were not exposed to UV-B radiation. Color analysis was performed using a colorimeter, with measurements of L* parameter (indicated as white values) and b* parameter (indicated as yellow values). Results are set forth in the following Table 11, Table 12, Table 13, Table 14, FIG. 2, FIG. 3, FIG. 4, and FIG. 5. As can be recognized, exposure to UV-B radiation was observed to produce an initial darkening of mushrooms after the exposure. However, beside this initial darkening, exposure to UV-B radiation was observed to inhibit further darkening and other discoloration of the mushrooms relative to controls that were not exposed to UV-B radiation. In particular, at some point between day 4 and day 10 (which may occur during the expected shelf life), the mushrooms that were exposed to UV-B radiation exhibited superior visual appearance relative to the controls.

TABLE 11

| White mushrooms | Day 0 | Day 4 | Day 10 |
|---|---|---|---|
| A Quality (Control) - white values | 87.4 | 86.2 | 66.5 |
| A Quality (UV 12 seconds) - | 85 | 80.9 | 72.8 |
| white values | | | |
| A Quality (Control) - yellow | 12.6 | 12.3 | 24 |
| values | | | |
| A Quality (UV 12 seconds) - | 12.9 | 16.1 | 21.2 |
| yellow values | | | |

TABLE 12

| White mushrooms | Day 0 | Day 4 | Day 10 |
|---|---|---|---|
| B Quality (Control) - white values | 88 | 88.3 | 70.9 |
| B Quality (UV 12 seconds) - | 86.7 | 83.1 | 81.2 |
| white values | | | |
| B Quality (Control) - yellow | 11.4 | 10.6 | 25.5 |
| values | | | |
| B Quality (UV 12 seconds) - | 11.9 | 14.2 | 17.8 |
| yellow values | | | |

TABLE 13

| Brown mushrooms | Day 0 | Day 4 | Day 10 |
|---|---|---|---|
| A Quality (Control) - white values | 90 | 86.9 | 73.8 |
| A Quality (UV 12 seconds) - | 85.4 | 82.7 | 79.8 |
| white values | | | |
| A Quality (Control) - yellow | 9.9 | 11.3 | 16.6 |
| values | | | |
| A Quality (UV 12 seconds) - | 11.6 | 13.7 | 16.1 |
| yellow values | | | |

TABLE 14

| Brown mushrooms | Day 0 | Day 4 | Day 10 |
|---|---|---|---|
| B Quality (Control) - white values | 86.3 | 84.6 | 74.2 |
| B Quality (UV 12 seconds) - | 83.5 | 79.8 | 76.1 |
| white values | | | |
| B Quality (Control) - yellow | 10 | 11 | 17.7 |
| values | | | |
| B Quality (UV 12 seconds) - | 11 | 13.1 | 16.2 |
| yellow values | | | |

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, process operation or operations, to the objective, spirit and scope of the invention. All such modifications are intended to be within the scope of the claims appended hereto. In particular, while the methods disclosed herein may have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

What is claimed is:

1. A method for treating fresh mushrooms comprising:
exposing the fresh mushrooms to a UV source having wavelengths in the UV-B range at a dose level in the range of about 0.02 J/cm² to about 1.5 J/cm²,
for an exposure time in the range of about 1 second to about 35 seconds,
wherein the UV source is operated at a power in the range of about 1 Watt per linear foot to about 50 Watts per linear foot, and
wherein the exposed mushrooms have a vitamin D₂ content of at least 400 IU per 84 g of the exposed mushrooms.

2. The method of claim 1, wherein the dose level is in the range of about 0.02 J/cm² to about 0.15 J/cm².

3. The method of claim 1, wherein the dose level is in the range of about 0.02 J/cm² to about 0.5 J/cm².

4. The method of claim 1, wherein the dose level is in the range of about 0.02 J/cm² to about 0.20 J/cm².

5. The method of claim 1, wherein the dose level is in the range of about 0.05 J/cm² to about 0.15 J/cm².

6. The method of claim 1, wherein the power is in the range of about 5 Watts per linear foot to about 25 Watts per linear foot.

7. The method of claim 6, wherein the power is in the range of about 10 Watts per linear foot to about 20 Watts per linear foot.

8. The method of claim 1, wherein the UV source is a continuous UV source.

9. The method of claim 1, wherein the UV source has a peak intensity in the range of 280 nm to 315 nm.

10. The method of claim 9, wherein the peak intensity is in the range of 310 nm to 315 nm.

11. The method of claim 1, wherein the exposure time is in the range of about 5 seconds to about 30 seconds.

12. The method of claim 1, wherein the exposure time is in the range of about 5 seconds to about 25 seconds.

13. The method of claim 2, wherein the exposure time is in the range of about 5 seconds to about 20 seconds.

14. The method of claim 13, wherein the exposure time is in the range of about 5 seconds to about 10 seconds.

15. The method of claim 1, wherein the fresh mushrooms are oriented such that gills of the fresh mushrooms face the UV source.

16. The method of claim 1, wherein the fresh mushrooms are sliced prior to exposure to the UV source.

17. The method of claim 1, further comprising slicing the exposed mushrooms.

18. The method of claim 16, wherein the slices have thicknesses in the range of ⅛ inch to ½ inch.

19. The method of claim 16, wherein the slices have thicknesses in the range of ¼ inch to 5/16 inch.

20. The method of claim 17, wherein the slices have thicknesses in the range of ⅛ inch to ½ inch.

21. The method of claim 17, wherein the slices have thicknesses in the range of ¼ inch to 5/16 inch.
